(19) United States
(12) Patent Application Publication
(10) Pub. No.: US 2016/0020031 A1
(43) Pub. Date: Jan. 21, 2016

(54) COMPOSITE ELECTRONIC COMPONENT AND BOARD HAVING THE SAME

(71) Applicant: SAMSUNG ELECTRO-MECHANICS CO., LTD., Suwon-Si (KR)

(72) Inventors: Hong Kyu SHIN, Suwon-Si (KR); Jae Hyuk CHOI, Suwon-Si (KR); Hyun Sub OH, Suwon-Si (KR)

(21) Appl. No.: 14/635,622

(22) Filed: Mar. 2, 2015

(30) Foreign Application Priority Data
Jul. 18, 2014 (KR) 10-2014-0091348
Oct. 31, 2014 (KR) 10-2014-0150692

(51) Int. Cl. H01G 4/38; H01G 4/12; H01G 2/06; H01G 4/248; H01G 4/012; H01G 4/30; H01G 9/052

(52) U.S. Cl. CPC H01G 4/38; H01G 4/30; H01G 4/12; H01G 9/052; H01G 4/248; H01G 4/012; H01G 2/065

(57) ABSTRACT

A composite electronic component includes: an insulating sheet; a tantalum capacitor including a body part containing a material formed of sintered tantalum powder particles and a tantalum wire partially embedded in the body part and disposed on the insulating sheet; a multilayer ceramic capacitor (MLCC) including a ceramic body in which dielectric layers and internal electrodes are alternatingly disposed and first and second external electrodes disposed on a lower surface of the ceramic body and disposed on the insulating sheet; and a molding part disposed to enclose the tantalum capacitor and the multilayer ceramic capacitor, wherein at least one of the tantalum capacitor and the multilayer ceramic capacitor includes a plurality of capacitors.

### CROSS-REFERENCE TO RELATED APPLICATIONS

This application claims the priorities and benefits of Korean Patent Application Nos. 10-2014-0091348 filed on Jul. 18, 2014, and 10-2014-0150692 filed on Oct. 31, 2014, with the Korean Intellectual Property Office, the disclosures of which are incorporated herein by reference.

### BACKGROUND

The present inventive concept relates to a composite electronic component including a plurality of passive elements and a board having the same.

A multilayer ceramic capacitor (MLCC), a multilayer chip electronic component, has a structure in which a plurality of dielectric layers, and internal electrodes disposed between the dielectric layers and having different polarities are stacked in an alternating manner.

Since the dielectric layer has piezoelectric and electrostrictive characteristics, a piezoelectric phenomenon may occur between the internal electrodes when a direct current (DC) or alternating current (AC) voltage is applied to a multilayer ceramic capacitor, such that vibrations may be generated.

These vibrations may be transferred to a printed circuit board (PCB) on which the multilayer ceramic capacitor is mounted through solders of the multilayer ceramic capacitor, such that the entire PCB may act as a sound radiating surface generating vibrational sound, commonly known as noise.

The vibrational sound may correspond to noise within an audio frequency in the range of 20 to 20000 hertz (Hz), sound which may cause discomfort to listeners thereof. Such vibrational sound causing listener discomfort, as described above may be termed acoustic noise.

Research into a product having a form in which a thickness of a lower cover layer of a multilayer ceramic capacitor is increased in order to decrease the generation of acoustic noise has been conducted.

However, research into a product having an improved acoustic noise reduction effect is required.

### RELATED ART DOCUMENT

Japanese Patent Laid-Open Publication No. 1997-326334

### SUMMARY

An aspect of the present inventive concept may provide a composite electronic component having an excellent acoustic noise reduction effect.

An aspect of the present inventive concept may also provide a composite electronic component having relatively low equivalent series resistance (ESR)/equivalent series inductance (ESL), improved direct current (DC)-bias characteristics, and a reduced chip thickness.

According to an aspect of the present inventive concept, a composite electronic component may include a composite body in which a multilayer ceramic capacitor and a tantalum capacitor are coupled to each other.

According to another aspect of the present inventive concept, a composite electronic component in which an inflection point of the impedance is generated in a frequency band lower than that of a self resonant frequency (SRF) in a graph illustrating impedance versus a frequency of an input signal may be provided.

According to still another aspect of the present inventive concept, a composite electronic component may include a composite body including a multilayer ceramic capacitor and a tantalum capacitor, wherein at least one of the multilayer ceramic capacitor and the tantalum capacitor includes a plurality of capacitors. Therefore, ESR of the composite electronic component may be further decreased.

According to yet another aspect of the present inventive concept, a board having a composite electronic component may include: a printed circuit board (PCB) on which electrode pads are disposed; the composite electronic component as described above mounted on the PCB; and solders connecting the electrode pads and the composite electronic component to each other.

### BRIEF DESCRIPTION OF DRAWINGS

The above and other aspects, features and other advantages of the present inventive concept will be more clearly understood from the following detailed description taken in conjunction with the accompanying drawings, in which:

FIG. 1 is a perspective view illustrating electrode terminals and a molding part of a composite electronic component according to an exemplary embodiment of the present inventive concept; and

FIG. 2 is a schematic top view for the perspective view of FIG. 1;

FIG. 3 is a cross-sectional view taken along line A-A′ of FIG. 1;

FIG. 4 is a cross-sectional view of a composite electronic component illustrating a modified example of a connection conductor part according to an exemplary embodiment of the present inventive concept;

FIG. 5 is enlarged views of regions C1 and C2 of FIG. 3;

FIG. 6 is a perspective view illustrating electrode terminals and a molding part of a composite electronic component according to another exemplary embodiment of the present inventive concept; and

FIG. 7 is a top view of FIG. 6;

FIG. 8A is a graph illustrating impedance of a composite electronic component including a single tantalum capacitor and a single multilayer ceramic capacitor; and FIG. 8B is a graph illustrating impedance of a component electronic component including two tantalum capacitors and a single multilayer ceramic capacitor;

FIG. 9 is a graph illustrating equivalent series resistance (ESR) of the composite electronic component including the two tantalum capacitors and the single multilayer ceramic capacitor of FIG. 8B;

FIG. 10 is a graph illustrating an output voltage versus time according to Inventive Example and Comparative Example;

FIG. 11 is a graph illustrating a voltage ripple (ΔV) as compared to ESR based on a volume ratio between a multilayer ceramic capacitor and a tantalum capacitor in a composite electronic component according to an exemplary embodiment of the present inventive concept; and

FIG. 12 is a perspective view illustrating a form in which the composite electronic component of FIG. 1 is mounted on a printed circuit board (PCB).

### DETAILED DESCRIPTION

Exemplary embodiments of the present inventive concept will now be described in detail with reference to the accompanying drawings.

The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art.

In the drawings, the shapes and dimensions of elements may be exaggerated for clarity, and the same reference numerals will be used throughout to designate the same or like elements.

As used herein, it will be further understood that the terms “include” and/or “have” when used in the present inventive concept, specify the presence of elements, but do not preclude the presence or addition of one or more other elements, unless otherwise indicated.

Further, in the present inventive concept, it will be understood that when an element is referred to as being formed “on” another element, it can be directly formed thereon or other intervening elements may be present.

In addition, in the present inventive concept, when an element is referred to as being “connected to,” it may be “directly connected to” and may also be “indirectly connected to” while having intervening elements therebetween.

Directions of a hexahedron will be defined in order to clearly describe exemplary embodiments of the present inventive concept. L, W and T shown in the accompanying drawings refer to a length direction, a width direction, and a thickness direction, respectively.

Composite Electronic Component

A composite electronic component according to an exemplary embodiment of the present inventive concept may include a composite body including a multilayer ceramic capacitor (MLCC) and a tantalum capacitor.

According to an exemplary embodiment of the present inventive concept, the multilayer ceramic capacitor and the tantalum capacitor may be connected in parallel with each other.

According to an exemplary embodiment of the present inventive concept, at least one of the multilayer ceramic capacitor and the tantalum capacitor included in the composite body may include a plurality of capacitors.

According to an exemplary embodiment of the present inventive concept, a composite electronic component including a multilayer ceramic capacitor and two tantalum capacitors may be provided.

According to an exemplary embodiment of the present inventive concept, a composite electronic component including a tantalum capacitor and two multilayer ceramic capacitors may be provided.

According to an exemplary embodiment of the present inventive concept, the composite electronic component may include an insulating sheet on which the multilayer ceramic capacitor and the tantalum capacitor are mounted, and a molding part enclosing the multilayer ceramic capacitor and the tantalum capacitor.

According to an exemplary embodiment of the present inventive concept, the composite electronic component may include a positive electrode terminal and a negative electrode terminal electrically connected to the multilayer ceramic capacitor and/or the tantalum capacitor.

According to an exemplary embodiment of the present inventive concept, the composite electronic component in which the multilayer ceramic capacitor is disposed in an assembled structure of the tantalum capacitor that does not include a lead frame and the tantalum capacitor and the multilayer ceramic capacitor are connected in parallel with each other may provide high capacitance.

According to an exemplary embodiment of the present inventive concept, an insulating layer may be disposed between the tantalum capacitor and the multilayer ceramic capacitor, and an electrical short-circuit may be prevented by the insulating layer.

According to an exemplary embodiment of the present inventive concept, due to a structure of the composite electronic component including the composite body in which the multilayer ceramic capacitor and the tantalum capacitor are coupled to each other, an excellent acoustic noise reduction effect may be achieved, high capacitance may be provided, equivalent series resistance (ESR)/equivalent series inductance (ESL) may be relatively low, direct current (DC)-bias characteristics may be improved, and a chip thickness may be reduced.

The tantalum capacitor may provide high capacitance, may have excellent DC-bias characteristics, and may not generate acoustic noise at the time of being mounted on a board.

On the other hand, the tantalum capacitor may have an issue of relatively high ESR.

Meanwhile, despite relatively low ESR and ESL, the multilayer ceramic capacitor may have relatively poor DC-bias characteristics and may have difficulty in providing high capacitance as compared to those of the tantalum capacitor.

In addition, the multilayer ceramic capacitor may have issues in that acoustic noise is generated at the time of mounting of the multilayer ceramic capacitor on the board.

However, since the composite electronic component according to an exemplary embodiment of the present inventive concept includes the composite body in which the multilayer ceramic capacitor and the tantalum capacitor are coupled to each other, relatively high ESR, a disadvantage of the tantalum capacitor, may be decreased.

In addition, deterioration of the DC-bias characteristics, a disadvantage of the multilayer ceramic capacitor, may be alleviated, and a relatively great chip thickness may be reduced.

Further, the multilayer ceramic capacitor that generates acoustic noise at the time of being mounted on the board and the tantalum capacitor that does not generate acoustic noise at the time of being mounted on the board may be coupled to each other at a predetermined volume ratio, whereby the excellent acoustic noise reduction effect may be achieved.

Further, in the composite electronic component, since a plating layer is not formed on external electrodes of the multilayer ceramic capacitor, deterioration of reliability due to permeation of a plating solution into the ceramic body may not be generated.

In addition, according to an exemplary embodiment of the present inventive concept, at least one of the tantalum capacitor and the multilayer ceramic capacitor may include a plurality of capacitors.

According to an exemplary embodiment of the present inventive concept, in the case in which the composite electronic component includes two tantalum capacitors and a single multilayer ceramic capacitor, ESR may be decreased and a noise removing effect in a high frequency band may be increased, as compared to the case in which the composite electronic component includes a single tantalum capacitor and a single multilayer ceramic capacitor. The multilayer ceramic capacitor may be disposed between the two tantalum capacitors.

Alternatively, according to an exemplary embodiment of the present inventive concept, the composite electronic component includes a single tantalum capacitor and two multilayer ceramic capacitors, whereby ESR of the composite electronic component may be further decreased.

As in the present exemplary embodiment, in the case in which the composite electronic component includes two multilayer ceramic capacitors and a single tantalum capacitor, ESR may further be decreased by about 40%, as compared to the case in which the composite electronic component includes two tantalum capacitors and a single multilayer ceramic capacitor as described above.

Therefore, the composite electronic component may have characteristics of a capacitor that may be used in a relatively high frequency band.

The tantalum capacitor may be disposed between the two multilayer ceramic capacitors.

In the composite electronic component including the composite body in which the tantalum capacitor and the multilayer ceramic capacitor are coupled to each other, a volume ratio between the tantalum capacitor and the multilayer ceramic capacitor coupled to each other is not particularly limited, but may be 5:5 to 7:3.

In a case in which the volume ratio of the tantalum capacitor is less than 5, a high capacitance electronic component may not be provided, and in a case in which the volume ratio of the tantalum capacitor exceeds 7, ESR and a voltage ripple (ΔV) value may rise.

In a composite electronic component according to another exemplary embodiment of the present inventive concept, in a graph illustrating impedance versus a frequency of an input signal, an inflection point of impedance may be generated in a frequency band lower than a frequency band of a self resonant frequency (SRF).

According to another exemplary embodiment of the present inventive concept, in the graph illustrating impedance to the frequency, impedance of the tantalum capacitor may appear in a relatively low frequency band, and impedance of the multilayer ceramic capacitor may appear in a relatively high frequency band.

Hereinafter, exemplary embodiments of the present inventive concept will be described with reference to the accompanying drawings.

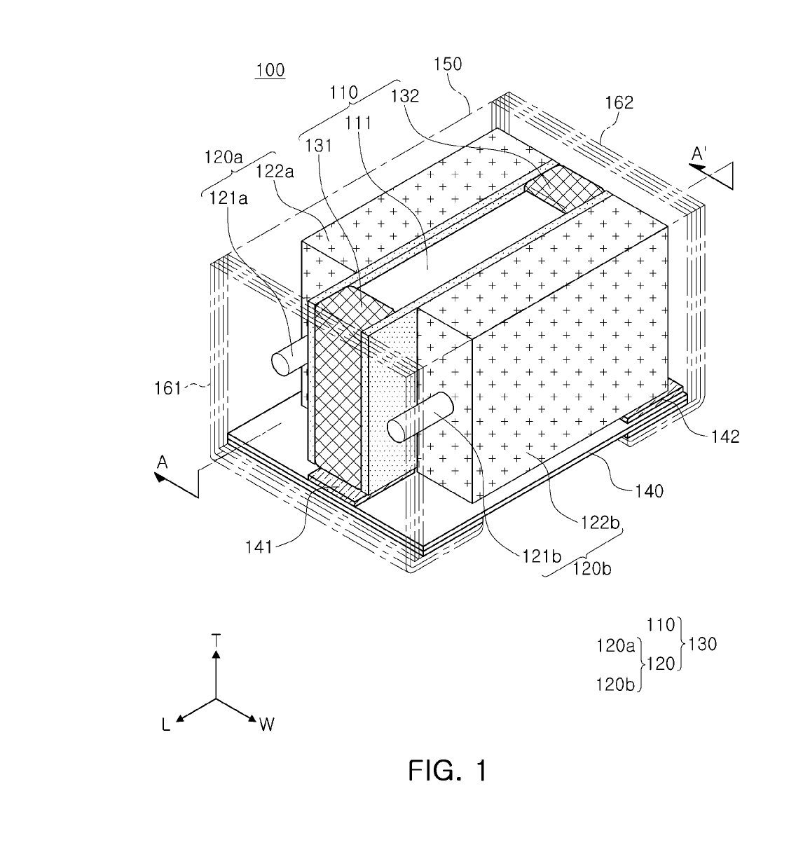

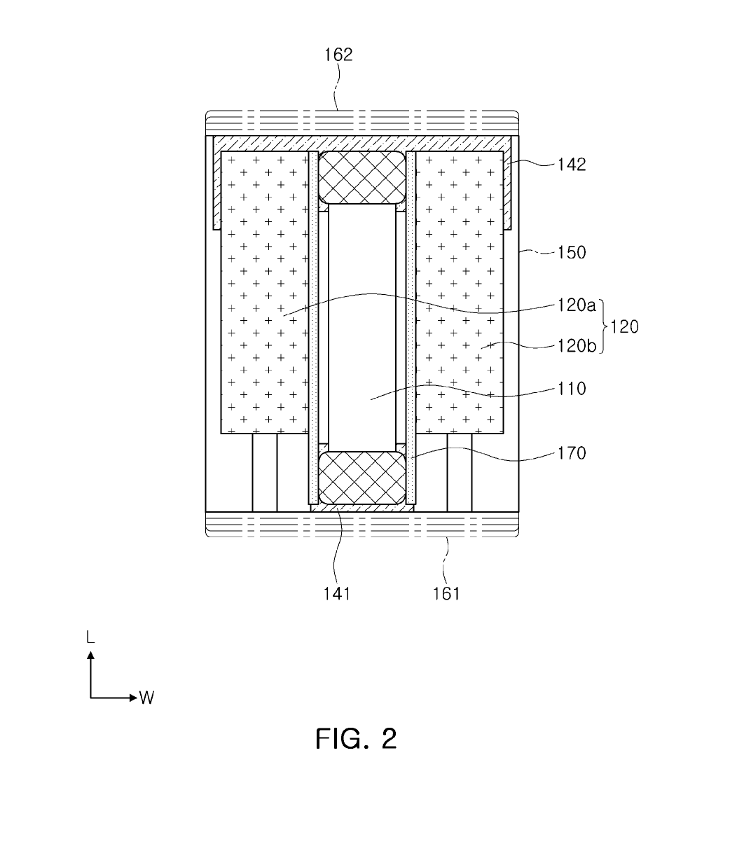

FIG. 1 is a perspective view illustrating electrode terminals and a molding part of a composite electronic component according to an exemplary embodiment of the present inventive concept; and FIG. 2 is a schematic top view for the perspective view of FIG. 1.

Referring to FIGS. 1 and 2, a composite electronic component 100 according to an exemplary embodiment of the present inventive concept may include an insulating sheet 140, a composite body 130 disposed on the insulating sheet 140 and including a multilayer ceramic capacitor 110 and two tantalum capacitors 120, a molding part 150, and electrode terminals 161 and 162.

The multilayer ceramic capacitor 110 is not particularly limited, but may be provided in various types of multilayer ceramic capacitors.

For example, the multilayer ceramic capacitor 110 may include a ceramic body 111 in which a plurality of dielectric layers and internal electrodes disposed to oppose each other with each of the dielectric layers interposed therebetween are stacked, and external electrodes 131 and 132 formed on outer surfaces of the ceramic body so as to be connected to the internal electrodes.

The ceramic body 111 may have an approximately hexahedral shape including upper and lower surfaces opposing each other in a thickness direction of the ceramic body 111, first and second side surfaces opposing each other in a length direction of the ceramic body 111, and third and fourth side surfaces opposing each other in a width direction of the ceramic body 111.

In an exemplary embodiment of the present inventive concept, the upper or lower surface of the ceramic body 111 may be a mounting surface adjacent to and facing the insulating sheet 140 when the multilayer ceramic capacitor is disposed on the insulating sheet, and subsequently to the multilayer ceramic capacitor being disposed on the insulating sheet 140, the mounting surface adjacent to and facing the insulating sheet may be the lower surface of the ceramic body 111 and a surface of the ceramic body 111 opposing the lower surface of the ceramic body 111 may be the upper surface of the ceramic body 111.

The internal electrodes may include first and second internal electrodes that may be alternatingly disposed on the dielectric layers with each of the dielectric layers interposed therebetween.

The ceramic body may be formed by stacking and then sintering the plurality of dielectric layers and the internal electrodes.

The dielectric layer may contain ceramic powder particles having a high-k, for example, barium titanate (BaTiO₃) based powder particles or strontium titanate (SrTiO₃) based powder particles. However, the type of powder contained in the dielectric layer is not limited thereto.

A material forming the first and second internal electrodes is not particularly limited, and may be a conductive paste formed of at least one selected from the group consisting of, for example, a noble metal material such as palladium (Pd), a palladium-silver (Pd—Ag) alloy, or the like, nickel (Ni), and copper (Cu).

The external electrodes 131 and 132 may be disposed on the outer surfaces of the ceramic body 111, respectively, and may be electrically connected to the internal electrodes. The external electrodes may include first and second external electrodes 131 and 132. The first external electrode 131 may be electrically connected to the first internal electrodes, and the second external electrode 132 may be electrically connected to the second internal electrodes.

According to an exemplary embodiment of the present inventive concept, nickel/tin (Ni/Sn) plating layers may not be disposed on the first and second external electrodes 131 and 132 unlike in a case of a general multilayer ceramic capacitor.

Since the composite electronic component includes the molding part 150 disposed to enclose the composite body 130 disposed on the upper surface of the insulating sheet 140 and including the multilayer ceramic capacitor 110 and the tantalum capacitors 120, the plating layers do not need to be formed on the first and second external electrodes 131 and 132 of the multilayer ceramic capacitor 110.

Therefore, an issue of reliability being decreased due to permeation of a plating solution into the ceramic body 111 of the multilayer ceramic capacitor 110 may be prevented.

The two tantalum capacitors 120 may have similar structures or different structures.

One of the two tantalum capacitors 120a and 120b will be called a first tantalum capacitor 120a, and the other thereof will be called a second tantalum capacitor 120b.

Hereinafter, although the first tantalum capacitor 120a of the first and second tantalum capacitors used in the exemplary embodiment of the present inventive concept will be described by way of example, a description of the first tantalum capacitor may be extended to a description of the second tantalum capacitor 120b.

For example, the tantalum capacitor 120a may include a body part 122a and a tantalum wire 121a, wherein the tantalum wire 121a may be embedded in the body part 122a so that a portion thereof in the length direction of the body part 122a is exposed.

The body part 122a of the tantalum capacitor may include a positive electrode body, a dielectric layer, a solid electrolyte layer, a carbon layer, and a negative electrode layer, but the layer to be included in the body part is not limited thereto.

The positive electrode body may be formed using tantalum and may be formed of a porous material of sintered tantalum powder particles.

The positive electrode body may have the dielectric layer formed on a surface thereof. The dielectric layer may be formed by oxidizing the surface of the positive electrode body. For example, the dielectric layer may be formed of a dielectric material formed of tantalum oxide (Ta₂O₅), which is an oxide of tantalum forming the positive electrode body, and may be formed at a predetermined thickness on the surface of the positive electrode body.

The dielectric layer may have the solid electrolyte layer formed on a surface thereof. The solid electrolyte layer may contain one or more of a conductive polymer and manganese dioxide (MnO₂).

In a case in which the solid electrolyte layer is formed of a conductive polymer, the solid electrolyte layer may be formed on the surface of the dielectric layer by using a chemical polymerization process or an electrolytic polymerization process. A material of the conductive polymer is not particularly limited as long as it is a polymer having conductivity, and may include, for example, polypyrrole, polythiophene, polyaniline, or the like.

In a case in which the solid electrolyte layer is formed of MnO₂, a conductive MnO₂ may be formed on the surface of the dielectric layer by immersing the positive electrode body having the dielectric layer formed on the surface thereof in a manganese aqueous solution such as a manganese nitrate and then decomposing the manganese aqueous solution by heating.

The carbon layer containing carbon may be disposed on the solid electrolyte layer.

The carbon layer may be formed of carbon pastes and may be formed by applying the carbon pastes in which conductive carbon material powder particles such as natural graphite, carbon black, or the like, are dispersed in water or an organic solvent in a state in which the conductive carbon material powder particles are mixed with a binder, a dispersing agent, or the like, onto the solid electrolyte layer.

The negative electrode layer containing a conductive metal may be disposed on the carbon layer in order to improve electrical connectivity with the negative electrode terminal, wherein the conductive metal contained in the negative electrode layer may be Ag.

According to the exemplary embodiment of the present inventive concept, as illustrated in FIGS. 1 and 2, the multilayer ceramic capacitor 110 may be disposed between the two tantalum capacitors 120a and 120b and may be connected in parallel with the two tantalum capacitors 120a and 120b.

According to the exemplary embodiment of the present inventive concept, the multilayer ceramic capacitor 110 may be disposed between the two tantalum capacitors 120a and 120b to provide considerably low ESR and to decrease acoustic noise.

In addition, in the case in which the two tantalum capacitors having a total of volumes equal to a volume of a single capacitor are disposed in a single chip component, an SRF of the composite electronic component may be increased and a noise removing effect of the composite electronic component in a relatively high frequency band may be improved based on the increase in the SRF, as compared to the case in which the single tantalum capacitor is disposed in the single chip component.

According to an exemplary embodiment of the present inventive concept, as illustrated in FIG. 2, the multilayer ceramic capacitor 110 and the tantalum capacitors 120 may be disposed on the insulating sheet 140.

The insulating sheet 140 is not particularly limited as long as it has an insulation property, but may be manufactured using an insulating material such as a ceramic based material, or the like.

The molding part 150 may cover the composite body 130 including the multilayer ceramic capacitor 110 and the tantalum capacitors 120, and the upper surface of the insulating sheet 140 having the multilayer ceramic capacitor and the tantalum capacitors disposed thereon.

The molding part 150 may protect the multilayer ceramic capacitor 110 and the tantalum capacitors 120 from an external environment, and may be mainly formed of an epoxy or silica based epoxy molding compound (EMC), or the like. However, the type of material forming the molding part 150 is not limited thereto.

The composite electronic component according to an exemplary embodiment of the present inventive concept may be provided as a single component in which the multilayer ceramic capacitor 110 and the tantalum capacitors 120 are coupled to each other, due to the molding part 150.

An insulating layer 170 may be disposed between the multilayer ceramic capacitor 110 and each of the tantalum capacitors 120, and an electrical short-circuit between respective elements of the composite electronic component disposed therein may be prevented by the insulating layer 170.

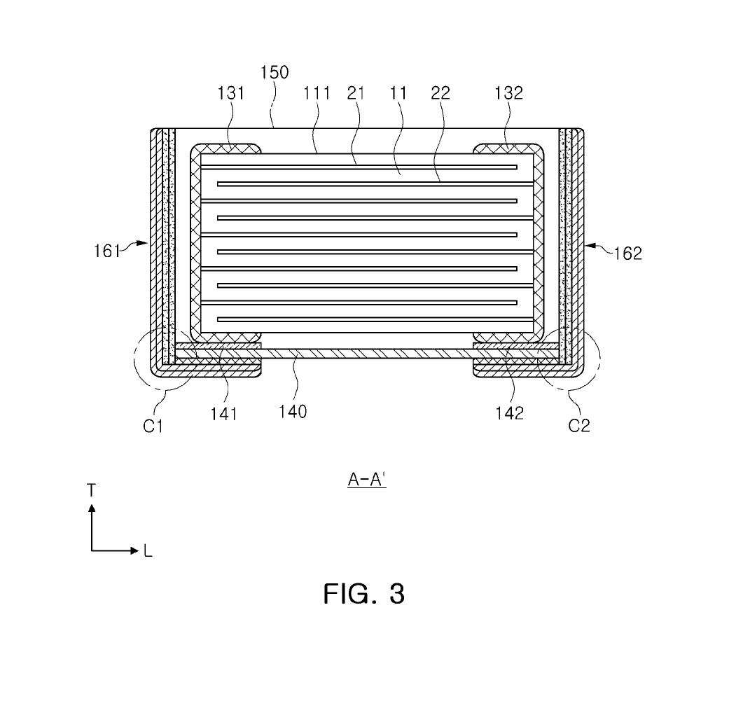

FIG. 3 is a cross-sectional view taken along line A-A′ of FIG. 1.

As illustrated in FIGS. 2 and 3, according to an exemplary embodiment of the present inventive concept, the composite electronic component 100 may include a positive electrode terminal 161 and a negative electrode terminal 162 electrically connected to the multilayer ceramic capacitor 110 and the tantalum capacitors 120.

According to an exemplary embodiment of the present inventive concept, the tantalum wires 121a and 121b and the first external electrode 131 of the multilayer ceramic capacitor may be connected to the positive electrode terminal 161, and the body parts 122a and 122b of the tantalum capacitors and the second external electrode 132 of the multilayer ceramic capacitor may be connected to the negative electrode terminal 162.

The tantalum wires 121a and 121b may be exposed to a first side surface of the molding part 150 in the length direction of the molding part 150 to be connected to the positive electrode terminal 161.

In the tantalum capacitors 120, that is, tantalum capacitors having a structure in which an internal lead frame is absent, the tantalum wires 121a and 121b may be exposed to the first side surface of the molding part 150 in the length direction of the molding part 150, thereby providing capacitance as high as possible as compared to a structure according to a related art.

As illustrated in FIG. 3, connection conductor parts 141 and 142 may be disposed on the upper surface of the insulating sheet 140.

The connection conductor parts 141 and 142 may have any shape as long as they contain conductive materials for electrically connecting the positive and negative electrode terminals 161 and 162 outside the molding part and the composite body 130 inside the molding part to each other, as will be described hereinbelow.

According to an exemplary embodiment of the present inventive concept, the positive electrode terminal 161 and the first external electrode 131 may be connected to each other through the first connection conductor part 141, and the body parts 122a and 122b and the second external electrode 132 may be connected to the negative electrode terminal 162 through the second connection conductor part 142.

The second connection conductor part 142 may be formed as a single part so as to connect all of the body parts 122a and 122b, the second external electrode 132, and the negative electrode terminal 162 to one another, or may be divided into two or more parts so as to connect the body parts 122a and 122b and the negative electrode terminal 162 to each other, and to connect the second external electrode 132 and the negative electrode terminal 162 to each other.

As illustrated in FIG. 3, the connection conductor parts 141 and 142 may have a shape of a metal pad, but the shape of the connection conductor parts 141 and 142 is not limited thereto.

In addition, the connection conductor parts 141 and 142 having the shape of the metal pad may contain Cu, but are not necessarily limited thereto.

The metal pads may include a first metal pad 141 connected to the first external electrode 131 to be thereby exposed to one side surface of the molding part 150, and a second metal pad 142 connected to the body part 122 and the second external electrode to be thereby exposed to the other side surface of the molding part 150.

In addition, the connection conductor parts may be formed of a plurality of patterns spaced apart from each other on the insulating sheet 140, or may be led out to the side surfaces of the molding part 150 to be thereby connected to the positive electrode terminal and/or the negative electrode terminal, as necessary.

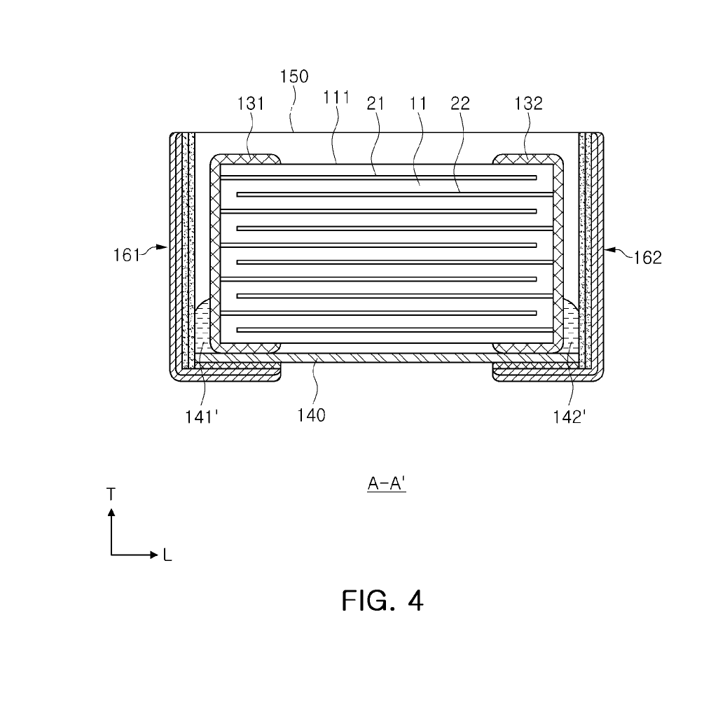

FIG. 4 is a cross-sectional view of the composite electronic component illustrating a modified example of a connection conductor part according to an exemplary embodiment of the present inventive concept.

As illustrated in FIG. 4, the connection conductor parts 141′ and 142′ may be conductive resin parts formed by hardening conductive resin pastes.

The conductive resin parts 141′ and 142′ may contain a conductive particle and a base resin.

The conductive particle may be a Ag particle, but is not limited thereto, and the base resin may be a thermosetting resin, for example, an epoxy resin.

In addition, the conductive resin parts 141′ and 142′ may contain Cu as a conductive metal, but is not necessarily limited thereto.

Further, although not illustrated in FIG. 4, the connection conductor parts according to an exemplary embodiment of the present inventive concept may include both of the above-mentioned metal pads and conductive resin parts.

According to an exemplary embodiment of the present inventive concept, space efficiency in the composite electronic component may be improved by a structure in which the internal lead frame is absent.

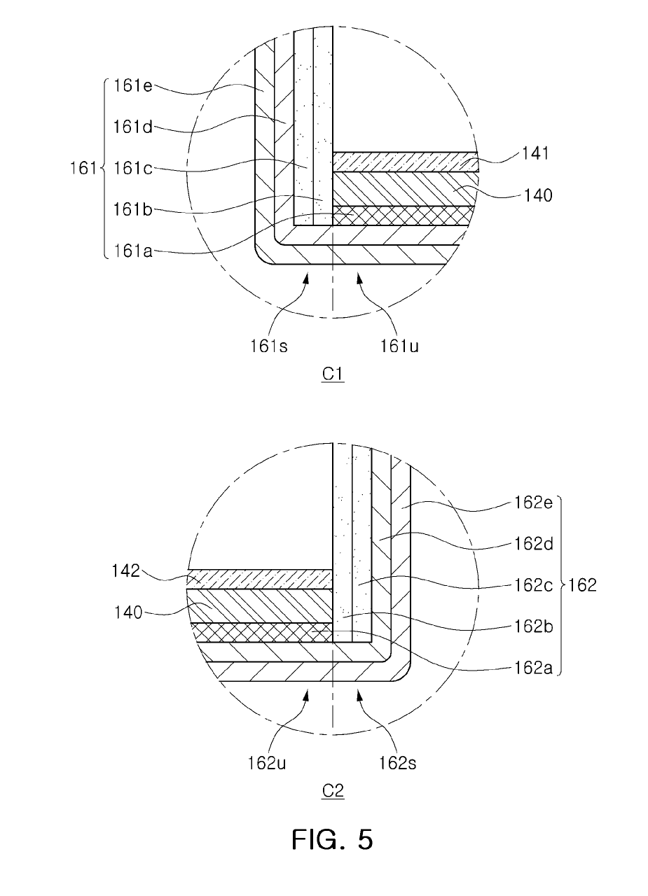

FIGS. 5A and 5B are enlarged views of regions C1 and C2 of FIG. 3.

Referring to FIGS. 3, 5A, and 5B, the electrode terminals may include the positive electrode terminal 161 and the negative electrode terminal 162.

The positive electrode terminal 161 may be disposed on the first side surface of the molding part 150 in the length direction of the molding part 150 and a lower surface of the insulating sheet, and may be connected to the tantalum wires 121a and 121b and the first external electrode 131.

The negative electrode terminal 162 may be disposed on a second side surface of the molding part 150 in the length direction of the molding part 150 and the lower surface of the insulating sheet, and may be connected to the body parts 122a and 122b and the second external electrode 132.

According to an exemplary embodiment of the present inventive concept, the positive electrode terminal 161 may be extended from the first side surface of the molding part 150 in the length direction of the molding part 150 onto a portion of the lower surface of the insulating sheet 140, the negative electrode terminal 162 may be extended from the second side surface of the molding part 150 in the length direction of the molding part 150 onto a portion of the lower surface of the insulating sheet 140, and the positive electrode terminal 161 and the negative electrode terminal 162 may be formed on the lower surface of the insulating sheet 140 to be spaced apart from each other.

The positive electrode terminal 161 may include a positive electrode side surface terminal part 161s disposed on the side surface of the molding part 150 and a positive electrode lower surface terminal part 161u disposed on the lower surface of the insulating sheet 140, and the negative electrode terminal 162 may include a negative electrode side surface terminal part 162s disposed on the side surface of the molding part 150 and a negative electrode lower surface terminal part 162u disposed on the lower surface of the insulating sheet 140.

According to an exemplary embodiment of the present inventive concept, the positive electrode terminal 161 may include a lower surface base layer 161a, side surface base layers 161b and 161c connected to the lower surface base layer 161a, and plating layers 161d and 161e disposed to enclose the lower surface base layer 161a and the side surface base layers 161b and 161c.

In addition, the negative electrode terminal 162 may include a lower surface base layer 162a, side surface base layers 162b and 162c connected to the lower surface base layer 162a, and plating layers 162d and 162e disposed to enclose the lower surface base layer 162a and the side surface base layers 162b and 162c.

Although the lower surface base layers 161a and 162a have been illustrated as single layers, respectively, and the side surface base layers 161b and 161c, and the side surface base layers 162b and 162c are illustrated as two separate layers, respectively, in FIGS. 5A and 5B, the disposition of the layers is not necessarily limited thereto, but may be provided in various manners.

The positive electrode terminal 161 and the negative electrode terminal 162 may be formed by processes of dry-depositing, for example, sputtering, and plating at least one of chromium (Cr), titanium (Ti), Cu, Ni, Pd, and gold (Au), forming a metal layer, and etching the metal layer, but the process of forming the positive electrode terminal 161 and the negative electrode terminal 162 is not limited thereto.

In addition, the positive electrode terminal 161 and the negative electrode terminal 162 may be formed by forming the lower surface base layers 161a and 162a and then forming the side surface base layers 161b, 161c, 162b, and 162c so as to be connected to the lower surface base layers 161a and 162a.

The lower surface base layers 161a and 162a may be formed by etching, but are not necessarily limited thereto.

The lower surface base layers 161a and 162a may be disposed on the lower surface of the insulating sheet 140, and may have patterns formed by applying a metal thin film to the lower surface of the insulating sheet 140 and then performing an etching process in order to form the lower surface base layers 161a and 162a.

The lower surface base layers 161a and 162a are not particularly limited, and may contain, for example, Cu.

In a case in which the lower surface base layers 161a and 162a are formed of Cu, an excellent connection of the lower surface base layers 161a and 162a to the positive to the side surface base layers 161b, 161c, 162b, and 162c formed by a separate process, and relatively high electrical conductivity may be obtained therebetween.

Meanwhile, the side surface base layers 161b, 161c, 162b, and 162c may be formed by a deposition process, for example, a sputtering process.

The side surface base layers 161b, 161c, 162b, and 162c are not particularly limited, but the side surface base layers 161b and 161c may be formed of two layers of an inner side and an outer side, respectively, and the side surface base layers 162b and 162c may be formed of two layers of an inner side and an outer side, respectively.

The inner side surface base layers 161b and 162b from among the side surface base layers 161b, 161c, 162b, and 162c may contain one or more of Cr or Ti, may be formed by the sputtering process, and may be connected to the lower surface base layers 161a and 162a.

The outer side surface base layers 161c and 162c from among the side surface base layers 161b, 161c, 162b, and 162c may contain Cu and may be formed by the sputtering process.

According to an exemplary embodiment of the present inventive concept, the tantalum capacitors and the multilayer ceramic capacitor may be connected in parallel with each other using an assembled structure of the tantalum capacitor.

According to an exemplary embodiment of the present inventive concept, the tantalum capacitors and the multilayer ceramic capacitor may be connected in parallel with each other on the insulating sheet used to form a positive electrode terminal and a negative electrode terminal of a frameless tantalum capacitor that does not include the internal lead frame.

According to an exemplary embodiment of the present inventive concept, the composite electronic component in which impedance of the tantalum capacitor appears in a relatively low frequency band and impedance of the multilayer ceramic capacitor appears in a relatively high frequency band may be provided.

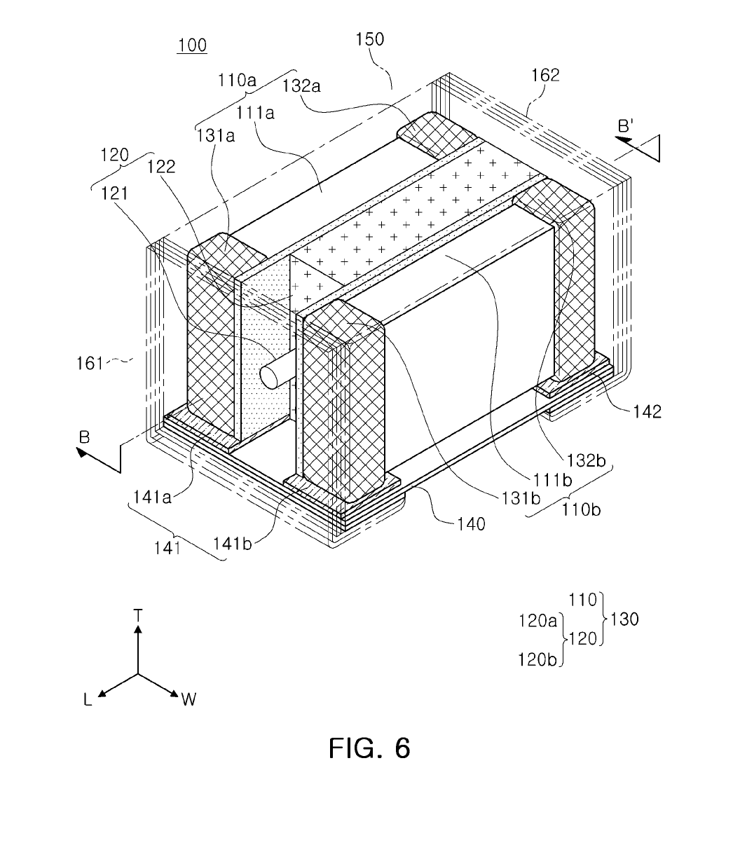

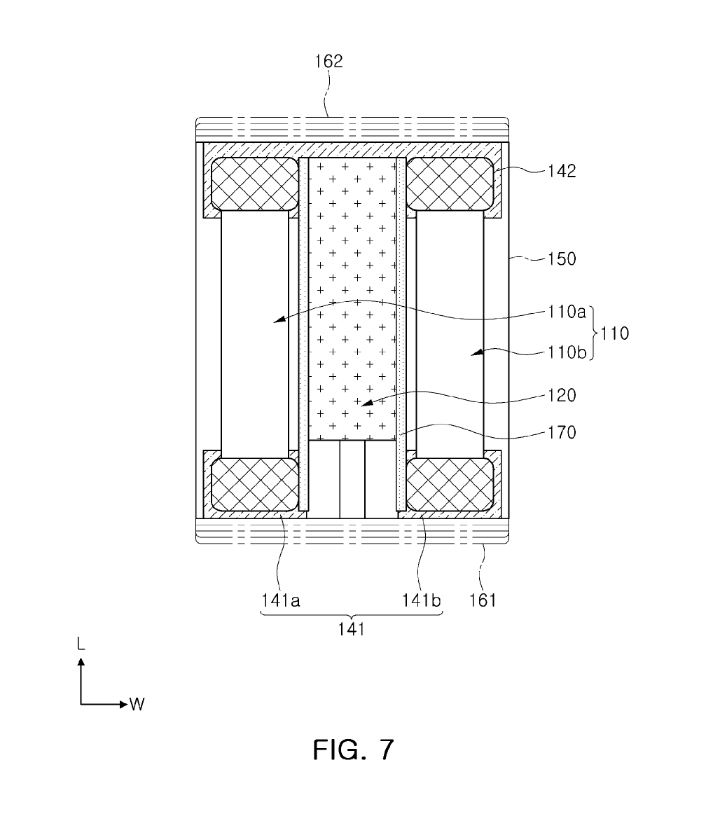

FIG. 6 is a perspective view illustrating electrode terminals and a molding part of a composite electronic component according to another exemplary embodiment of the present inventive concept; and FIG. 7 is a top view of FIG. 6.

Referring to FIGS. 6 and 7, a composite electronic component according to another exemplary embodiment of the present inventive concept may include two multilayer ceramic capacitors 110a and 110b and a single tantalum capacitor 120.

For example, the composite electronic component according to the present exemplary embodiment may include a first multilayer ceramic capacitor 110a, a second multilayer ceramic capacitor 110b, and the tantalum capacitor 120 disposed between the first and second multilayer ceramic capacitors.

In a case in which the single composite electronic component including the tantalum capacitor and the multilayer ceramic capacitor includes the two multilayer ceramic capacitors as in the other exemplary embodiment of the present inventive concept, ESR may further be decreased as compared to the above-mentioned exemplary embodiment of the present inventive concept, such that the composite electronic component according to the other exemplary embodiment of the present inventive concept may be used in a frequency band higher than a frequency band in which the composite electronic component according to the exemplary embodiment of the present inventive concept is used.

Insulation layers 170 may be disposed between the first multilayer ceramic capacitor 110a and the tantalum capacitor 120 and may be disposed between the second multilayer ceramic capacitor 110b and the tantalum capacitor 120, respectively, and an electrical short-circuit between the respective elements of the composite electronic component disposed in the composite electronic component may be prevented by the insulating layers.

The composite electronic component according to the other exemplary embodiment of the present inventive concept may include the molding part 150 disposed to enclose the tantalum capacitor and the two multilayer ceramic capacitors.

A tantalum wire 121 of the tantalum capacitor 120 may be exposed through one side surface of the molding part 150 to be thereby electrically connected to the positive electrode terminal 161, and a body part 122 of the tantalum capacitor may be electrically connected to the negative electrode terminal 162 disposed on the other side surface of the molding part 150.

In addition, first external electrodes 131a and 131b of the first and second multilayer ceramic capacitors 110a and 110b, respectively, may be connected to the positive electrode terminal 161 disposed on one side surface of the molding part 150, and second external electrodes 132a and 132b of the first and second multilayer ceramic capacitors 110a and 110b, respectively, may be connected to the negative electrode terminal 162 disposed on the other side surface of the molding part 150.

Since a description of other contents of the composite electronic component according to the other exemplary embodiment of the present inventive concept is identical to the description of the contents of the composite electronic component according to the exemplary embodiment of the present inventive concept described above, a repeated description thereof will be omitted for conciseness.

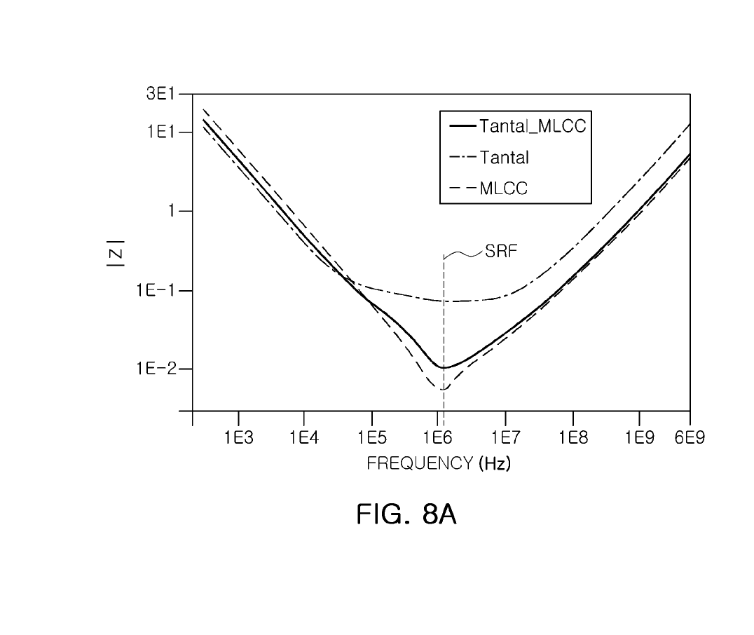

FIG. 8A is a graph illustrating impedance of a composite electronic component including a single tantalum capacitor and a single multilayer ceramic capacitor; and FIG. 8B is a graph illustrating impedance of a component electronic component including two tantalum capacitors and a single multilayer ceramic capacitor. In FIGS. 8A and 8B, volume ratios of tantalum capacitors are set to be the same as each other, respectively.

It may be appreciated that an SRF of the composite electronic component moves to a relatively high frequency band in FIG. 8B as compared to FIG. 8A, and it may be appreciated from FIG. 8B that in a case in which the composite electronic component includes a plurality of tantalum capacitors, the SRF is increased, such that a noise removing effect in a relatively high frequency band is increased.

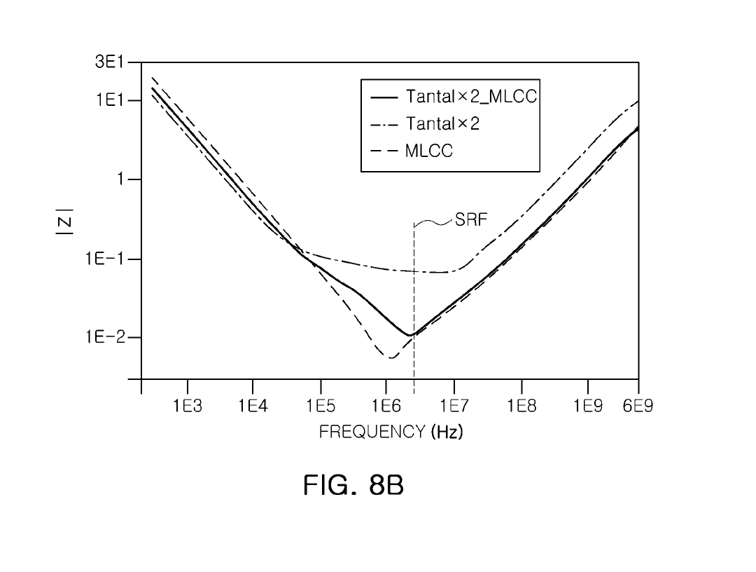

FIG. 9 is a graph illustrating ESR of the composite electronic component including the two tantalum capacitors and the single multilayer ceramic capacitor of FIG. 8B.

Referring to FIGS. 8B and 9, in the graphs illustrating impedance versus a frequency of an input signal and ESR versus a frequency of an input signal, respectively, in a composite electronic component according to an exemplary embodiment of the present inventive concept, inflection points of impedance and ESR may be generated in at least one of frequency bands prior to and subsequent to an SRF.

According to an exemplary embodiment of the present inventive concept, in the graph illustrating impedance versus the frequency, impedance of the tantalum capacitors may appear in a relatively low frequency band, and impedance of the multilayer ceramic capacitor may appear in a relatively high frequency band.

Therefore, in the graphs illustrating ESR versus the frequency of the input signal and impedance versus the frequency of the input signal, respectively, the inflection points of ESR and impedance may be generated in at least one of the frequency bands prior to and subsequent to the SRF.

The inflection points of ESR and impedance may be generated in at least one of the frequency bands prior to and subsequent to the SRF, or may be generated in both of the frequency bands prior to and subsequent to the SRF.

Since the inflection points of the ESR and the impedance are generated in at least one of the frequency bands prior to and subsequent to the SRF, the composite electronic component according to an exemplary embodiment of the present inventive concept may provide relatively low ESR.

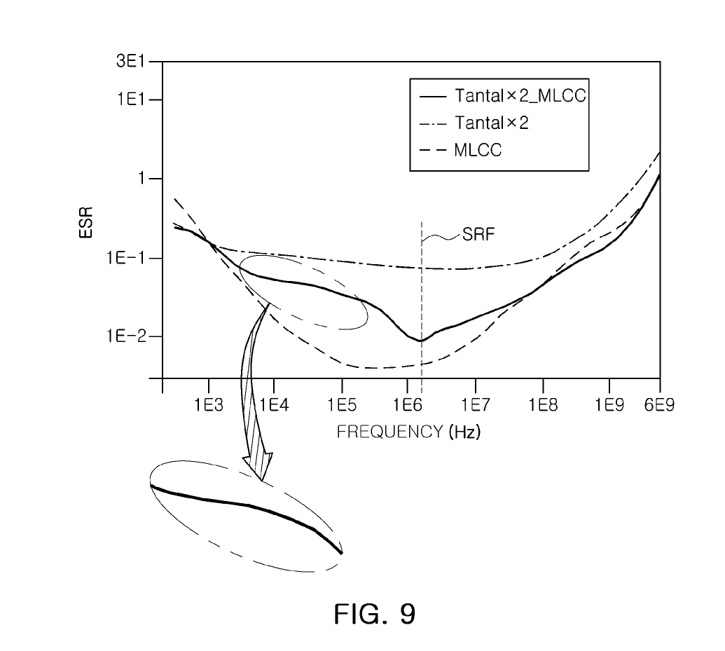

FIG. 10 is a graph illustrating an output voltage versus time according to Inventive Example and Comparative Example.

Referring to FIG. 10, it may be appreciated that a voltage ripple of Inventive Example is significantly decreased as compared to that of Comparative Example in which only the tantalum capacitor is used, and is substantially similar to that of Comparative Example in which only the multilayer ceramic capacitor is used.

That is, it may be appreciated that in the case of Comparative Example in which only the tantalum capacitor is used, a voltage ripple is 34 millivolts (mV), while in the case of Inventive Example, a voltage ripple is decreased to 9 mV, which is similar to that (7 mV) of Comparative Example in which only the multilayer ceramic capacitor is used.

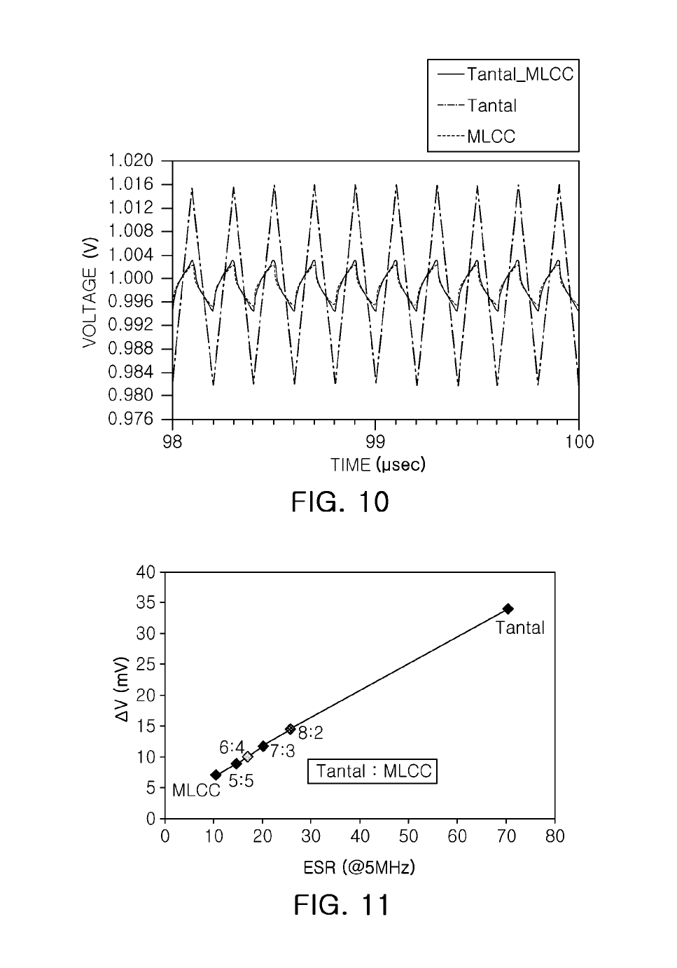

FIG. 11 is a graph illustrating a voltage ripple (ΔV) versus ESR based on a volume ratio between a multilayer ceramic capacitor and a tantalum capacitor in a composite electronic component according to an exemplary embodiment of the present inventive concept.

Referring to FIG. 11, it may be appreciated that in an exemplary embodiment of the present inventive concept, in a case in which a volume ratio between the tantalum capacitor and the multilayer ceramic capacitor coupled to each other is 5:5 to 7:3, an electronic component having relatively low ESR, a relatively low voltage ripple (ΔV) value, and relatively high capacitance may be provided.

Board Having Composite Electronic Component

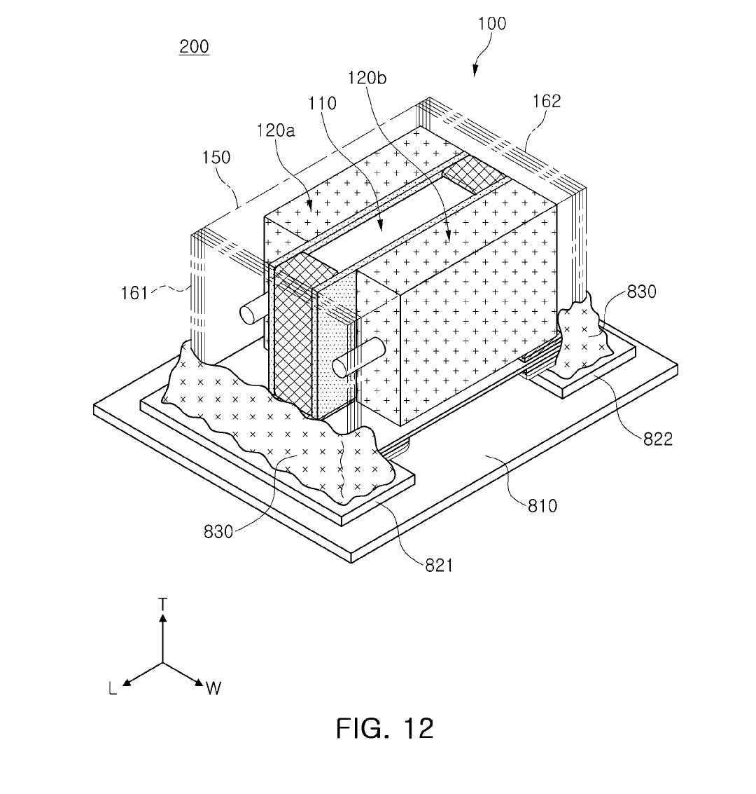

FIG. 12 is a perspective view illustrating a form in which the composite electronic component of FIG. 1 is mounted on a PCB.

Referring to FIG. 12, a board 200 having a composite electronic component according to another exemplary embodiment of the present inventive concept may include a PCB 810 on which electrode pads 821 and 822 are disposed, the composite electronic component 100 mounted on the PCB 810, and solders 830 connecting the electrode pads 821 and 822 and the composite electronic component 100 to each other.

The composite electronic component may be the composite electronic component according to the exemplary embodiment of the present inventive concept or the composite electronic component according to the other exemplary embodiment of the present inventive concept described above.

The board 200 having the composite electronic component according to the present exemplary embodiment may include the PCB 810 on which the composite electronic component 100 is mounted and two or more electrode pads 821 and 822 formed on an upper surface of the PCB 810.

The electrode pads 821 and 822 may include first and second electrode pads 821 and 822 connected to the positive electrode terminal 161 and the negative electrode terminal 162 of the composite electronic component, respectively.

Here, the positive electrode terminal 161 and the negative electrode terminal 162 of the composite electronic component may be electrically connected to the PCB 810 by the solders 830 in a state in which the solders 830 are positioned on the first and second electrode pads 821 and 822 to be in contact with the first and second electrode pads 821 and 822, respectively.

As set forth above, according to exemplary embodiments of the present inventive concept, the composite electronic component having an excellent acoustic noise reduction effect may be provided.

In addition, according to exemplary embodiments of the present inventive concept, the composite electronic component capable of providing relatively high capacitance, having relatively low ESR/ESL, improved DC-bias characteristics, and a reduced chip thickness may be provided.

Further, according to exemplary embodiments of the present inventive concept, the composite electronic component having an excellent noise removing effect in a relatively high frequency band may be provided.

While exemplary embodiments have been shown and described above, it will be apparent to those skilled in the art that modifications and variations could be made without departing from the scope of the invention as defined by the appended claims.

What is claimed is:

1. A composite electronic component comprising:
an insulating sheet;
a tantalum capacitor including a body part containing a material formed of sintered tantalum powder particles and a tantalum wire partially embedded in the body part, and disposed on the insulating sheet;
a multilayer ceramic capacitor (MLCC) including a ceramic body in which dielectric layers and internal electrodes are alternatingly disposed and first and second external electrodes disposed on a lower surface of the ceramic body, and disposed on the insulating sheet; and
a molding part disposed to enclose the tantalum capacitor and the multilayer ceramic capacitor,
wherein at least one of the tantalum capacitor and the multilayer ceramic capacitor includes a plurality of capacitors.

2. The composite electronic component of claim 1, wherein the tantalum capacitor includes a first tantalum capacitor and a second tantalum capacitor disposed to be spaced apart from the first tantalum capacitor.

3. The composite electronic component of claim 2, wherein the multilayer ceramic capacitor is disposed between the first and second tantalum capacitors.

4. The composite electronic component of claim 1, wherein the multilayer ceramic capacitor includes a first multilayer ceramic capacitor and a second multilayer ceramic capacitor disposed to be spaced apart from the first multilayer ceramic capacitor.

5. The composite electronic component of claim 4, wherein the tantalum capacitor is disposed between the first and second multilayer ceramic capacitors.

6. The composite electronic component of claim 1, further comprising a positive electrode terminal disposed on a first side surface of the molding part in a length direction of the molding part and a lower surface of the molding part, and a negative electrode terminal disposed on a second side surface of the molding part in the length direction of the molding part and the lower surface of the molding part.

7. The composite electronic component of claim 6, wherein the first external electrode of the multilayer ceramic capacitor and the tantalum wire of the tantalum capacitor are connected to the positive electrode terminal.

8. The composite electronic component of claim 6, wherein the second external electrode of the multilayer ceramic capacitor and the body part of the tantalum capacitor are connected to the negative electrode terminal.

9. The composite electronic component of claim 6, wherein the positive electrode terminal and the negative electrode terminal include a lower surface base layer, side surface base layers connected to the lower surface base layer, and plating layers disposed to enclose the lower surface base layer and the side surface base layers.

10. The composite electronic component of claim 9, wherein the lower surface base layer is formed by etching.

11. The composite electronic component of claim 9, wherein the side surface base layer is formed by deposition.

12. The composite electronic component of claim 1, wherein the tantalum wire is exposed to a first side surface of the molding part in a length direction of the molding part.

13. The composite electronic component of claim 1, wherein in a graph illustrating an equivalent series resistance (ESR) versus a frequency of an input signal, an inflection point of the ESR is generated in at least one of frequency bands prior to and subsequent to a self resonant frequency (SRF).

14. The composite electronic component of claim 1, wherein an insulating layer is disposed between surfaces of the respective multilayer ceramic capacitor and the tantalum capacitor through which the multilayer ceramic capacitor and the tantalum capacitor are coupled to each other.

15. The composite electronic component of claim 1, further comprising connection conductor parts disposed on an upper surface of the insulating sheet.

16. The composite electronic component of claim 15, wherein the connection conductor part contains a metal pad.

17. The composite electronic component of claim 15, wherein the connection conductor part includes a conductive resin.

18. A board having a composite electronic component, comprising:
a printed circuit board (PCB) on which electrode pads are disposed;
a composite electronic component mounted on the PCB; and
solders connecting the electrode pads and the composite electronic component to each other,
wherein the composite electronic component includes: an insulating sheet, a tantalum capacitor including a body part containing a material formed of sintered tantalum powder particles and a tantalum wire partially embedded in the body part, and disposed on the insulating sheet, a multilayer ceramic capacitor including a ceramic body in which dielectric layers and internal electrodes are alternatingly disposed and first and second external electrodes disposed on a lower surface of the ceramic body, and disposed on the insulating sheet, and a molding part disposed to enclose the tantalum capacitor and the multilayer ceramic capacitor, and
at least one of the tantalum capacitor and the multilayer ceramic capacitor includes a plurality of capacitors.
